(19) United States
(12) Patent Application Publication
(10) Pub. No.: US 2026/0035211 A1
(43) Pub. Date: Feb. 5, 2026

(54) ELEVATOR CAR, ELEVATOR SYSTEM AND METHOD OF ACCESSING A SPACE IN A HOISTWAY OF AN ELEVATOR SYSTEM

(71) Applicant: Otis Elevator Company, Farmington, CT (US)

(72) Inventors: Gerard Sirigu, Gien (FR); Pascal Rebillard, Gien (FR)

(21) Appl. No.: 19/279,472

(22) Filed: Jul. 24, 2025

(30) Foreign Application Priority Data
Jul. 31, 2024 (EP) 24306296.5

(51) Int. Cl. B66B 11/02; B66B 13/30

(52) U.S. Cl. CPC B66B 11/0246; B66B 13/30

(57) ABSTRACT

An elevator car (6) for moving in a hoistway (4) between a plurality of landings (8a-8d) includes a floor hatch (22) formed at a bottom of the elevator car (6) and allowing a person to access a space (24) in a portion of the hoistway (4) below the elevator car (6) from inside the elevator car (6). The elevator car (6) further includes at least one movable fixing element (34) that is movable between an elevator car fixing position in which it fixes the position of the elevator car (6) in a hoistway (4) at a predefined position above a bottom of the hoistway (4), and a released position, in which it does not fix the position of the elevator car (6) in the hoistway (4).

### FOREIGN PRIORITY

This application claims priority to European Patent Application No. 24306296.5, filed Jul. 31, 2024, and all the benefits accruing therefrom under 35 U.S.C. § 119, the contents of which in its entirety are herein incorporated by reference.

### TECHNICAL FIELD OF INVENTION

The invention relates to an elevator car for an elevator system, wherein the elevator car allows for accessing a space that is located in a hoistway of the elevator system below the elevator car. The invention further relates to an elevator system comprising such an elevator car. The invention also relates to a method of accessing a space that is located in a hoistway of the elevator system below the elevator car.

### BACKGROUND OF THE INVENTION

An elevator system typically comprises at least one elevator car configured for moving along a hoistway extending between a plurality of landings.

For inspection, repair and/or maintenance, a person, in particular a mechanic, may need to enter the hoistway. The person may in particular need to enter a space that is located in a lower portion of the hoistway below the elevator car, in particular between the bottom of the elevator car and the bottom of the hoistway.

When a person is in the hoistway, especially below the elevator car, it creates a potentially dangerous situation, in particular when the elevator system has a low pit, in particular with a pit having a height of less than 2 m, as there is a risk that the person is hit or squeezed by the elevator car when the elevator car is moving downwards.

It would therefore be beneficial to provide an improved elevator system with an improved elevator car that allows a person to conveniently access the hoistway, in particular to access a space below the elevator car, wherein the elevator system enhances the safety of the person located in the hoistway, in particular in a portion of the hoistway below the elevator car.

### SUMMARY OF THE INVENTION

According to an exemplary embodiment of the invention, an elevator car that is configured for moving in a hoistway between a plurality of landings comprises a floor hatch that is formed at a bottom of the elevator car in order to allow a person, in particular a mechanic, to access a space located in a portion of the hoistway below the elevator car from inside the elevator car. The elevator car further comprises at least one movable fixing element that is configured for selectively fixing the position of the elevator car in the hoistway at a predefined position above a bottom of the hoistway. The at least one movable fixing element is coupled with the floor hatch in order to be activated by opening the floor hatch.

Exemplary embodiments of the invention further include an elevator system comprising a hoistway extending between a plurality of landings and an elevator car according to an exemplary embodiment of the invention that is arranged in the hoistway for moving between the plurality of landings.

Exemplary embodiments of the invention also include a method of accessing a space in the hoistway below the elevator car in an elevator system according to an exemplary embodiment of the invention, wherein the method includes: moving the elevator car to a predefined position in the hoistway; activating the at least one movable fixing element for fixing the position of the elevator car in the hoistway at the predefined position by opening the floor hatch provided at the bottom of the elevator car; and accessing the space in the portion of the hoistway below the elevator car from the elevator car via a floor opening that is formed in the floor of the elevator car by opening the floor hatch.

According to exemplary embodiments of the invention, the position of the elevator car in the hoistway is fixed by the at least one movable fixing element when the floor hatch is opened. In consequence, the elevator car is prevented from moving along the hoistway as soon as a person opens the floor hatch for accessing and/or entering the hoistway, in particular for accessing and/or entering a space in a portion of the hoistway below the elevator car, more particularly a space that is located between the bottom of the elevator car and the bottom of the hoistway.

According to exemplary embodiments of the invention, the at least one movable fixing element is automatically activated for fixing the position of the elevator car in the hoistway when the floor hatch is opened, thereby preventing any further movement of the elevator car and enhancing the safety of the person in the hoistway.

In an elevator system according to an exemplary embodiment of the invention, a person may enter the hoistway conveniently from the elevator car. There is, in particular, no need for providing a manual unlocking mechanism in or at the lowest landing door for allowing the person to enter a portion of the hoistway below the elevator car via the lowest landing door.

In the following, a number of optional features of an elevator car, an elevator system and a method of accessing a space in the hoistway of an elevator system according to exemplary embodiments of the invention are set out. These features may be realized in particular embodiments, alone or in combination with any of the other features, unless explicitly stated otherwise.

The floor hatch may include one of a trap door comprising at least one panel or lid that is pivotable around an axis, a sliding door comprising at least one panel or lid that is linearly movable, in particular slidable, between an open position and a closed position, and a combination of a floor opening formed in the floor of the elevator car and at least one cover that may be positioned above and/or within the floor opening for closing and/or covering the floor opening. The cover may be removable from the floor opening for providing access to a portion of the hoistway below the elevator car through the floor opening.

The elevator system may further comprise at least one fixing opening provided in the hoistway. The at least one fixing opening may, for example, be formed in a wall of the hoistway or in a guide rail extending through the hoistway.

The at least one movable fixing element may be movable between a fixing position for fixing position of the elevator car in the hoistway, and a released position in which it does not fix the position of the elevator car in the hoistway. The at least one movable fixing element may be in the fixing position when it is activated, and it may be in the released position when it is deactivated.

When activated and arranged in the elevator car fixing position, the at least one movable fixing element may extend into the at least one fixing opening for preventing any movement of the elevator car along the hoistway. When deactivated and arranged in the released position, the at least one movable fixing element does not extend into the at least one fixing opening and allows the elevator car to move along the hoistway.

The at least one movable fixing element and the at least one fixing opening are components of a fixing mechanism of the elevator system.

For increasing the mechanical strength of the fixing mechanism, the fixing mechanism may comprise a plurality of movable fixing elements and a plurality of corresponding openings.

The at least one movable fixing element may be mechanically and/or electrically coupled with the floor hatch of the elevator car for moving concurrently with the floor hatch in order to ensure that the at least one movable fixing element is always and inevitably activated when the floor hatch is opened.

An electric coupling may include at least one electric switch that is configured for detecting whether the floor hatch is in an open position or in a closed position. The fixing mechanism may, for example, be an electromechanical fixing mechanism that is electrically activated and deactivated based on the switching state of the at least one electric switch.

The elevator car may comprise at least one of a lever, a rope, a belt, a rack and a pinion providing a mechanical coupling element for mechanically coupling the floor hatch with the at least one fixing element in order to ensure that the at least one fixing element is moved into the elevator car fixing position when the floor hatch is opened.

The elevator car may further comprise a floor hatch fixing mechanism that is configured for fixing the floor hatch in an open position in order to prevent the floor hatch from closing while a person is still present in the space located in a portion of the hoistway below the elevator car.

A method according to an exemplary embodiment of the invention may include fixing the floor hatch in its open position, in particular by activating a floor hatch fixing mechanism.

Providing such a floor hatch fixing mechanism and fixing the floor hatch in its open position may enhance the safety of the elevator system even further as it may prevent the floor hatch from accidentally closing while a person is still present in a space in the hoistway below the elevator car.

The floor hatch fixing mechanism may include a mechanical fixing mechanism and/or an electrical fixing mechanism. The floor hatch fixing mechanism may in particular include an electromechanical fixing mechanism that may include a solenoid for selectively fixing and releasing the floor hatch in its open position.

The floor hatch fixing mechanism may be configured such that it is releasable only from inside the elevator car, i.e. by a person located inside the elevator car, but not from outside the elevator car, i.e. by a person located outside the elevator car, in particular not from the hoistway. Such a configuration may prevent the person from releasing the floor hatch fixing mechanism and closing the floor hatch while the person is still in the hoistway, in particular in the space below the elevator car.

An elevator system according to an exemplary embodiment of the invention may further comprise a floor hatch locking mechanism. The floor hatch locking mechanism may be configured for locking the floor hatch in its closed position when the elevator car is not positioned at the predefined position in the hoistway. The floor hatch locking mechanism may further be configured for unlocking the floor hatch when the elevator car is positioned at the predefined position in the hoistway. Such a locking mechanism may enhance the safety of the elevator system by preventing the floor hatch from being opened when the elevator car is not positioned at the predefined position in the hoistway. The floor hatch locking mechanism may, in particular, prevent the floor hatch from being opened when the elevator car is located in an upper portion of the hoistway, where opening the floor hatch would be very dangerous.

The floor hatch locking mechanism may comprise a locking element, such as a rod or a bolt, provided at the elevator car. The locking element may be movable between a locked position in which it locks the floor hatch, and an unlocked or released position in which it does not lock the floor hatch.

The floor hatch locking mechanism may further comprise an actuator, such as a roller, that is configured for moving the locking element from the locked position into the unlocked position when the elevator car is located at the predefined position in the hoistway. Such an actuator may allow for automatically and reliably unlocking the floor hatch locking mechanism when the elevator car is located at the predefined position in the hoistway.

Automatically unlocking the floor hatch locking mechanism may facilitate the handling of the floor hatch, since the floor hatch locking mechanism does not need to be operated manually. In addition, the risk of an incorrect manual operation of the floor hatch locking mechanism may be reduced or even eliminated.

The actuator may be located in the hoistway. The actuator may, for example, be mounted to a wall of the hoistway or to a guide member provided in the hoistway.

The floor hatch locking mechanism may further comprise a floor hatch lock indicator indicating whether or not the floor hatch is locked by the floor hatch locking mechanism. Providing a floor hatch lock indicator may prevent a person from unsuccessfully trying to open the floor hatch when it is still locked by the floor hatch locking mechanism.

The floor hatch lock indicator may include a mechanical indicator, such as a movable pointer or a movable flag, and/or an electric indicator, such as a light source, in particular an LED.

The elevator system may further comprise an elevator controller that is configured for controlling the movement of the elevator car in the hoistway. The elevator controller may be switchable between a mode of normal operation for moving passengers between the plurality of landings, and a maintenance mode that differs from the mode of normal operation. When switched into the maintenance mode, the elevator controller may be configured for positioning the elevator car at the predefined position in the hoistway. When switched into the maintenance mode, the elevator controller may in particular cause a drive system of the elevator system to move the elevator car along the hoistway until the elevator car is positioned at the predefined position in the hoistway.

The elevator controller may be switchable between the mode of normal operation and the maintenance mode by inputting specific control commands into a control panel of the elevator system, in particular into an elevator car control panel provided inside the elevator car or into one of the landing control panels provided at the landings.

Additionally or alternatively, the elevator controller may be switchable between the mode of normal operation and the maintenance mode by a separate control tool, in particular by a mobile maintenance tool. The control tool may be configured for communication with the elevator controller via a wired data link or via a wireless data link.

The elevator car may comprise a floor hatch motor, in particular an electric floor hatch motor, for moving the floor hatch between a closed position and an open position. Moving the floor hatch by a floor hatch motor may be convenient for the person aiming for access to a space in the hoistway below the elevator car.

Additionally or alternatively, the floor hatch may comprise at least one handle for allowing the person to move the floor hatch manually between the closed position and the open position. Moving the floor hatch manually is very reliable. It further allows for reducing the weight and the costs of the elevator car by not adding a floor hatch motor to the elevator car.

The elevator system may comprise a plurality of landing doors provided at the plurality of landings. The plurality of landing doors may include a lowest landing door provided at the lowest landing and other landing doors provided at other landings above the lowest landing.

At least some of the other landing doors, i.e. some of the landing doors that are not located at the lowest landing, may comprise a manual unlocking mechanism that allows for manually unlocking the respective landing door from the respective landing in order to provide access to the hoistway from the respective landing. Landing doors comprising such manual unlocking mechanisms may be beneficial for inspection, maintenance and/or repair of the elevator system, and/or for rescuing passengers from the elevator car in case of a malfunction of the elevator system.

The lowest landing door may, however, be formed without a manual unlocking mechanism so that a space located at the bottom of the hoistway is accessible not from the lowest landing, but only from inside the elevator car via the floor hatch, as it has been described before. Such a configuration may allow for preventing persons, in particular mechanics, from entering a space located at the bottom of the hoistway, in particular a space below the elevator car, via the lowest landing door without activating the at least one movable fixing element of the elevator car that is coupled to the floor hatch, as it has been described before, which would result in a potentially dangerous situation.

The features, modifications and effects that have been described with respect to an elevator car and an elevator system according to exemplary embodiments of the invention analogously apply to a method of accessing a space in the hoistway of an elevator system according to an exemplary embodiment of the invention.

### BRIEF DESCRIPTION OF THE DRAWINGS

In the following, exemplary embodiments of the invention are described in more detail with respect to the enclosed figures:

FIG. 1 depicts a schematic view of an elevator system according to an exemplary embodiment of the invention.

FIGS. 2A to 2D schematically illustrate a method of accessing a space in the hoistway of an elevator system according to an exemplary embodiment of the invention.

FIGS. 3A-3D schematically illustrate the functionality of a fixing mechanism of an elevator system according to an exemplary embodiment of the invention.

FIGS. 4A and 4B schematically depict a floor hatch locking mechanism of an elevator system according to an exemplary embodiment of the invention.

FIG. 4C depicts an exemplary embodiment of a floor hatch locking mechanism for locking the floor hatch in its closed position.

FIG. 5A depicts a schematic sectional view of the floor of an elevator car of an elevator system according to an exemplary embodiment of the invention with the floor hatch arranged in a closed position.

FIG. 5B depicts a schematic top view of the of the floor of the elevator car depicted in FIG. 5A.

FIG. 6A depicts a schematic sectional view of the floor of an elevator car of an elevator system according to an exemplary embodiment of the invention with the floor hatch arranged in a partially open position.

FIG. 6B depicts a schematic top view of the of the floor of the elevator car depicted in FIG. 6A.

FIG. 7A depicts a schematic sectional view of the floor of an elevator car of an elevator system according to an exemplary embodiment of the invention with the floor hatch arranged in a fully open position.

FIG. 7B depicts a schematic top view of the of the floor of the elevator car depicted in FIG. 7A.

FIG. 8 depicts an exemplary embodiment of a floor hatch fixing mechanism that allows fixing the floor hatch in its vertical open position.

FIG. 9 depicts a schematic perspective view of a portion of the floor of the elevator car of an elevator system according to an exemplary embodiment of the invention.

### DETAILED DESCRIPTION OF THE INVENTION

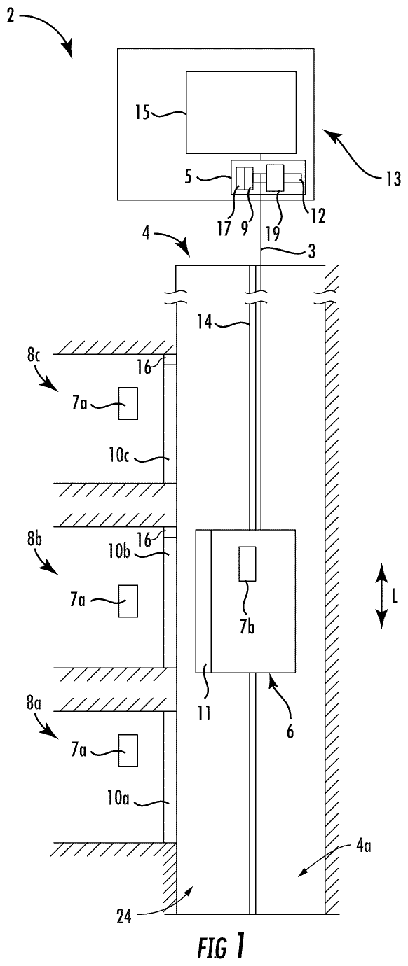

FIG. 1 schematically depicts an elevator system 2 according to an exemplary embodiment of the invention.

The elevator system 2 comprises a hoistway 4 extending in a longitudinal direction L between a plurality of landings 8a-8c located on different floors. The elevator system 2 includes an elevator car 6 arranged in the hoistway 4 for being moved along the longitudinal direction L between the plurality of landings 8a-8c. The elevator car 6 may in particular be movable along at least one elevator car guide member 14, such as at least one elevator car guide rail, provided in the hoistway 4 and extending along the longitudinal direction L.

The longitudinal direction L may be oriented in a vertical direction, as it is depicted in FIG. 1. In an alternative embodiment not depicted in the figures the longitudinal direction L may be inclined with respect to the vertical direction.

Although only a single elevator car guide member 14 is visible in FIG. 1, the elevator system 2 may comprise a plurality of elevator car guide members 14.

Although only a single elevator car 6 is depicted in FIG. 1, exemplary embodiments of the invention may include elevator systems 2 comprising a plurality of elevator cars 6 moving in one or more hoistways 4.

The elevator car 6 is movably suspended by means of a tension member 3.

The tension member 3, for example a rope or belt, is coupled to an elevator drive system 5. The elevator drive system 5 comprises a motor 9 for rotatably driving a shaft 12, and a drive 17 that harnesses and controls the electrical energy supplied to the motor 9. The elevator drive system 5 is configured for driving the tension member 3, which is coupled to the shaft 12, in order to move the elevator car 6 in the hoistway 4 along the longitudinal direction L between the plurality of landings 8a-8c.

The elevator drive system 5 is further provided with at least one elevator brake 19 for braking rotation of the shaft 12 in order to allow for stopping movement of the elevator car 6.

The elevator system 2 may further include an elevator counterweight, which is not depicted in FIG. 1. The elevator counterweight may be attached to the tension member 3 opposite to the elevator car 6 and configured for moving concurrently and in opposite direction with respect to the elevator car 6 along at least one elevator counterweight guide member, which is also not shown in FIG. 1.

Exemplary embodiments of the invention may be employed in elevator systems 2 comprising a counterweight and in elevator systems 2 that do not comprise an elevator counterweight.

The tension member 3 may be a rope, e.g. a steel cord, or a belt, in particular a coated steel belt. The tension member 3 may be uncoated. Alternatively, the tension member 3 may be coated with a coating, e.g. with a coating having the form of a polymer jacket. In a particular embodiment, the tension member 3 may be a belt comprising a plurality polymer coated steel cords (not shown). The elevator system 2 may have a traction drive including a traction sheave for driving the tension member 3.

The exemplary embodiment shown in FIG. 1 uses a 1:1 roping for suspending the elevator car 6. The skilled person easily understands that the type of the roping is not essential for the invention and that different kinds of roping, e.g. a 2:1 roping or a 4:1 roping may be used as well.

A landing door 10a-10c is provided at each of the landings 8a-8c, respectively.

At least some of the landing doors 10a-10c, in particular landing doors 10b, 10c that are not located at the lowest landing 8a, may comprise a manual unlocking mechanism 16 that allows for manually unlocking the respective landing door 10b, 10c from the respective landing 8b, 8c for providing access to the hoistway 4 from the respective landing 8b-8c. Landing doors 10b, 10c comprising such manual unlocking mechanisms 16 may be beneficial for inspection, maintenance and/or repair of the elevator system 2, and/or for rescuing passengers from the elevator car 6 in case of a malfunction of the elevator system 2.

The landing door 10a at the lowest landing 8a may, however, be formed without a manual unlocking mechanism 16 so that a space 24 located at a bottom 4a of the hoistway 4 is accessible not from the lowest landing 8a, but only from inside the elevator car 6. Such a configuration may allow for preventing persons 20 from entering a space 24 located at the bottom 4a of the hoistway 4, in particular a space 24 below the elevator car 6, via the landing door 10a at the lowest landing 8a.

The elevator car 6 is provided with an elevator car door 11 for allowing passengers to transfer between a landing 8a-8c and the interior of the elevator car 6, when the elevator car 6 is positioned at the respective landing 8a-8c.

For moving the elevator car 6 along the hoistway 4 between the different landings 8a-8c, the elevator drive system 5 may be controlled by an elevator controller 15 of the elevator system 2.

The elevator system 2 may comprise a machine room 13 housing the elevator drive system 5 and the elevator controller 15. Alternatively, the elevator system 2 may be a machine room-less elevator system 2.

Input to the elevator controller 15 may be provided via landing control panels 7a provided on every landing 8a-8c, in particular in the vicinity of the landing doors 10, and/or via an elevator car control panel 7b provided inside the elevator car 6.

The landing control panels 7a may comprise elevator hall call buttons and/or destination call buttons. Destination call buttons allow passengers to enter their respective destinations before entering the elevator car 6. In case the landing control panels 7a are equipped with destination call buttons, no elevator car control panel 7b needs to be provided inside the elevator car 6 since the elevator system 2 is fully controlled by the commands input via the landing control panels 7a.

The landing control panels 7a and the elevator car control panel 7b may be coupled to the elevator controller 15 by means of electrical wiring not shown in FIG. 1, in particular by an electric bus, or by wireless data connections.

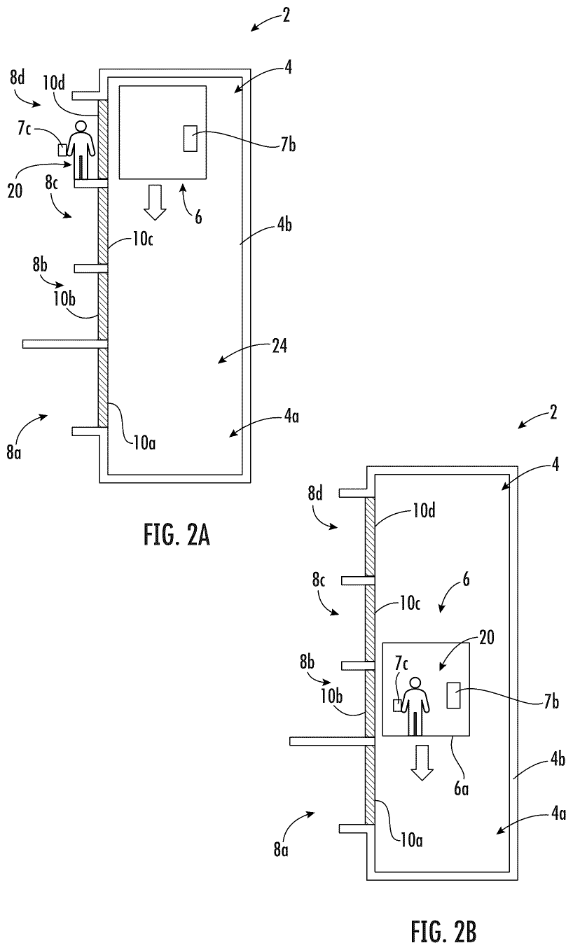

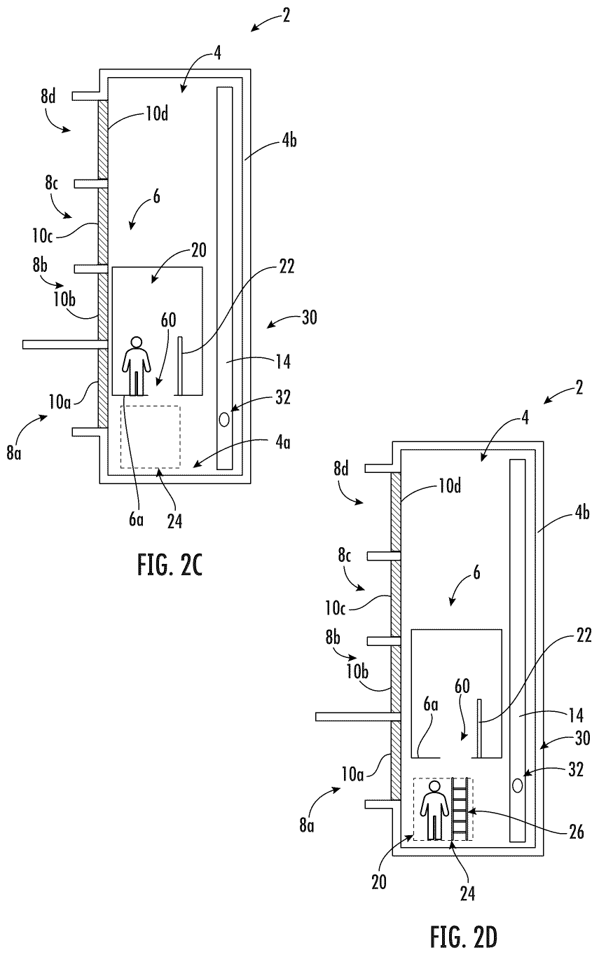

FIGS. 2A to 2D schematically illustrate a method of accessing a space 24 located in the hoistway 4 of the elevator system 2 below the elevator car 6, in particular a space 24 at the bottom 4a of the hoistway 4, according to an exemplary embodiment of the invention.

In FIG. 2A, a person 20, in particular a mechanic, is present at one of the landings 8a-8d and requests the elevator controller 15 to move the elevator car 6 to said landing 8d. Although the person 20 is shown at the uppermost landing 8d, the person 20 may be located at any landing 8a-8d of the elevator system 2.

After the elevator car 6 has arrived at the landing 8d at which the person 20 is located, the person 20 enters the elevator car 6 through the landing door 10d.

The person 20 may enter the elevator car 6 like a normal passenger. The person 20 does in particular not need any specific tools or keys for entering the elevator car 6.

After the person 20 has entered the elevator car 6, the person 20 instructs the elevator controller 15 to move the elevator car 6 to a predefined position in the hoistway 4 of the elevator system 2, in particular to a predefined position that allows the person 20 to access and/or enter the space 24 at the bottom 4a of the hoistway 4 from the bottom of the elevator car 6.

The person 20 may in particular switch the elevator controller 15 from a mode of normal operation that is configured for moving passengers between the different landings 8a-8d into a maintenance mode.

The person 20 may supply instruction to the elevator controller 15 by entering commands via the elevator car control panel 7b and/or via a specific mobile control tool 7c that is configured for communicating with the elevator controller 15.

The mobile control tool 7c may communicate with the elevator controller 15 via a wired data connection (not shown) or via a wireless data connection.

FIG. 2B shows the elevator car 6 moving towards the bottom 4a of the hoistway 4 in response to a control command input by the person 20.

In FIG. 2C the elevator car 6 has reached the predefined position in the hoistway 4 and stopped at said predefined position.

The predefined position of the elevator car 6 may be a position at one of the landings 8a-8d, in particular a position at the lowest landing 8a. Alternatively, the predefined position may be a position between two adjacent landings 8a-8d, as it is depicted in FIG. 2C, or a position below the lowest landing 8a.

After the elevator car 6 has reached the predefined position in the hoistway 4, the person 20 opens a floor hatch 22 that is formed in the floor 6a of the elevator car 6. Before opening the floor hatch 22, the person 20 may unlock the floor hatch 22, if necessary.

The person 20 may then enter into the space 24 that is formed between the bottom of the elevator car 6 and the bottom 4a of the hoistway 4 via a floor opening 60 that is formed in the floor 6a of the elevator car 6 by opening the floor hatch 22, as it is depicted in FIG. 2D.

Optionally, the person 20 may use a ladder 26 for conveniently entering said space 24 by climbing down the ladder 26.

For enhancing the safety of the person 20, the elevator car 6 is prevented from moving, in particular from moving downwards, while the floor hatch 22 is open and the person 20 is in the space 24 below the elevator car 6.

In order to prevent the elevator car 6 from moving while the floor hatch 22 is open, the elevator system 2 is provided with a fixing mechanism 30 that is configured for fixing the position of the elevator car 6 in the hoistway 4 at the predefined position above the bottom 4a of the hoistway 4 while the floor hatch 22 is open.

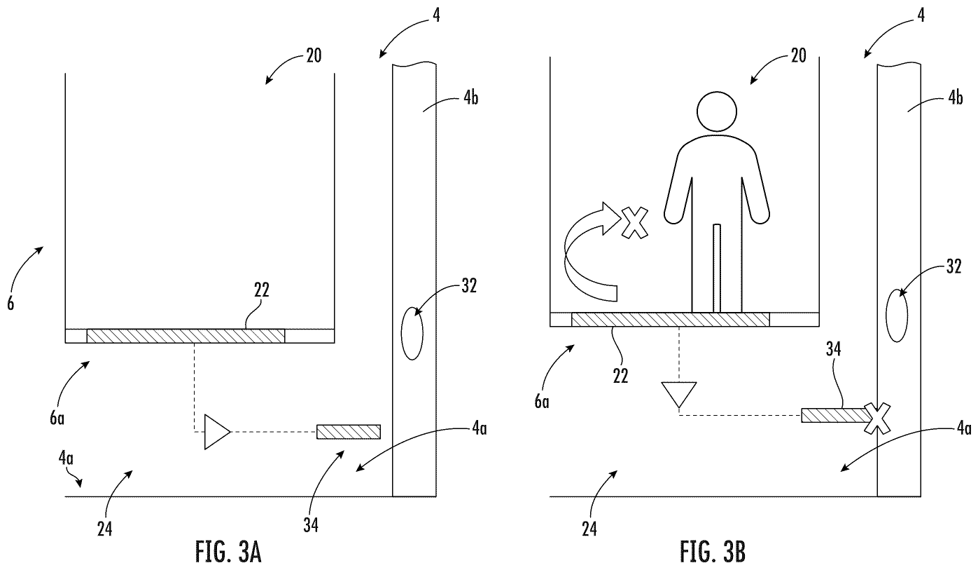

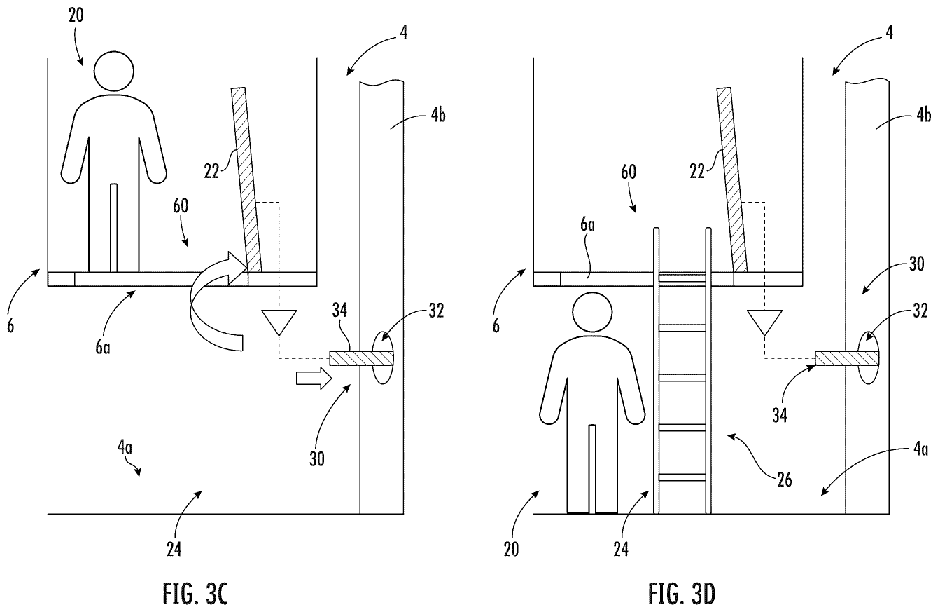

The functionality of the fixing mechanism 30 is schematically illustrated in FIGS. 3A-3D.

The fixing mechanism 30 includes a fixing opening 32 provided in the hoistway 4. The fixing opening 32 may, for example, be formed in a wall 4b of the hoistway 4. The fixing opening 32 may also be formed in a guide rail 14 extending through the hoistway 4.

The fixing mechanism 30 further comprises a movable fixing element 34 provided at the elevator car 6. The movable fixing element 34 is movable between an elevator car fixing position in which the movable fixing element 34 extends into the fixing opening 32, as it is depicted in FIGS. 3C and 3D, and a released position in which the movable fixing element 34 does not extend into the fixing opening 32, as it is depicted in FIGS. 3A and 3B.

The elevator car fixing position may be denoted as activated position of the movable fixing element 34, and the released position may be denoted as deactivated position of the movable fixing element 34.

The fixing mechanism 30 is mechanically or electrically coupled with the floor hatch 22 in order to be activated automatically when the floor hatch 22 is opened.

The fixing mechanism 30 may in particular be coupled with the floor hatch 22 in a configuration that prevents the person 20 from opening the floor hatch 22 when the elevator car 6 is not positioned at the predefined position in the hoistway 4.

FIG. 3B depicts a situation in which the elevator car 6 is not positioned at the predefined position in the hoistway 4.

In consequence, the movable fixing element 34 of the fixing mechanism 30 is not positioned at the same height above the bottom 4a of the hoistway 4 as the fixing opening 32. In consequence, the movable fixing element 34 is not able to move into the fixing opening 32.

The coupling between the floor hatch 22 and the fixing element 34 may be configured such that the floor hatch 22 may not be moved from its closed position depicted in FIG. 3B into its open position depicted in FIGS. 3C and 3D when the fixing element 34 is not able to move into the fixing opening 32.

Such a coupling between the floor hatch 22 and the fixing element 34, i.e. a coupling that causes the fixing mechanism 30 to act as a locking mechanism that locks the floor hatch 22 when the elevator car 6 is not positioned at the predefined position in the hoistway 4, may enhance the safety of the elevator system 2 even further by preventing the person 20 from entering the space 24 below the elevator car 6 without activating the fixing mechanism 30.

FIG. 3C shows the elevator car 6 positioned at the predefined position above the bottom 4a of the hoistway 4. The fixing element 34 of the fixing mechanism 30 has been moved into the corresponding fixing opening 32 by opening the floor hatch 22.

In consequence, the vertical position of the elevator car 6 above the bottom 4a of the hoistway 4 is securely fixed by the fixing mechanism 30 so that it is safe for the person 20 to enter the space 24 below the elevator car 6.

In FIG. 3D the person 20 has entered the space 24 below the elevator car 6, for example by using a ladder 26 that has been lowered into the space 24 below the elevator car 6.

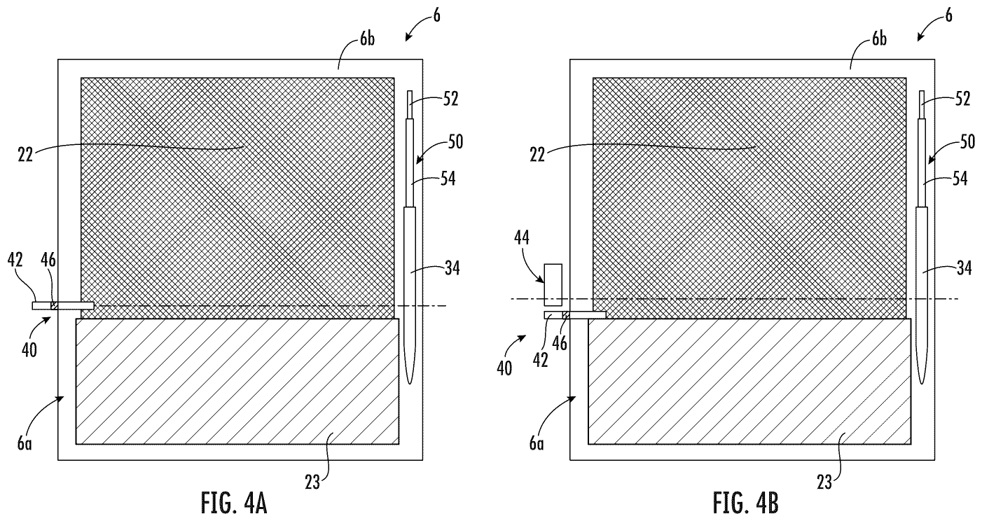

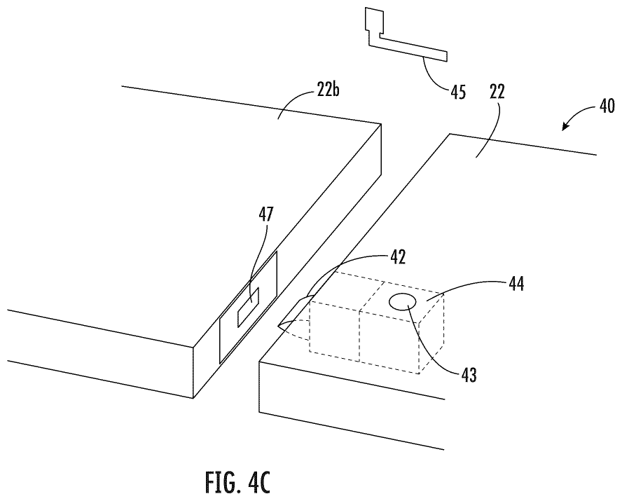

In the following the elevator car 6 and the fixing mechanism 30 will be described in more detail with reference to FIGS. 4A to 7.

FIGS. 4A and 4B depict schematic plain views of the floor 6a of an elevator car 6 of an elevator system 2 according to the present invention.

The floor 6a of the elevator car 6 comprises a fixed portion 23 that is not movable with respect to a frame 6b of the elevator car 6 and the floor hatch 22 that may be moved into an open position for providing access to the space 24 below the elevator car 6, as it has been discussed before with reference to FIGS. 2A to 3D.

In the exemplary embodiment depicted in the figures, the floor hatch 22 is provided as a trap door that is pivotable around an axis A.

The floor hatch 22 being a trap door is, however, only an exemplary configuration, and in alternative embodiments that are not explicitly depicted in the figures, the floor hatch 22 may have alternative configurations as well. The floor hatch 22 may, for example, include a sliding door that is linearly movable between a closed position and an open position. In a further embodiment, the floor hatch 22 may include a floor opening 60 formed in the floor 6a of the elevator car 6 and a cover that may be positioned in and/or above the floor opening 60 for closing and/or covering the floor opening 60. The cover may be removed from the floor opening 60 for providing access to the space 24 below the elevator car 6 via the floor opening 60.

Optionally, the elevator car 6 may further comprise a floor hatch locking mechanism 40. The floor hatch locking mechanism 40 may be configured for looking the floor hatch 22 in its closed position when the elevator car 6 is not positioned at the predefined position in the hoistway 4, and for unlocking the floor hatch 22 in order to allow for opening the floor hatch 22 when the elevator car 6 is positioned at the predefined position in the hoistway 4.

In the exemplary embodiment depicted in FIGS. 4A and 4B, the floor hatch locking mechanism 40 comprises a floor hatch locking element 42, for example a rod or bolt, that is movable between a locked position in which it blocks movement of the floor hatch 22 and an unlocked position in which it does not block movement of the floor hatch 22.

The locked position of the floor hatch locking element 42 is schematically depicted in FIG. 4A, and the unlocked position of the floor hatch locking element 42 is schematically depicted in FIG. 4B.

The floor hatch locking mechanism 40 further comprises an actuator 44, for example a roller, provided at a predetermined position in the hoistway 4 and configured for moving, in particular urging, the locking element 42 from the locked position into the unlocked position when the elevator car 6 is located at the predefined position in the hoistway 4.

In an elevator system 2 comprising such a floor hatch locking mechanism 40, persons 20 are reliably prevented from opening the floor hatch 22 when the elevator car 6 is not positioned at the predefined position in the hoistway 4. As a result, providing a floor hatch locking mechanism 40 may enhance the safety of the elevator system 2 even further.

Optionally, the floor hatch locking mechanism 40 may comprise a floor hatch lock indicator 46 for indicating whether or not the floor hatch 22 is locked by the floor hatch locking mechanism 40.

A floor hatch lock indicator 46 may prevent the person 20 from unsuccessfully trying to open the floor hatch 22 when it is locked by the floor hatch locking mechanism 40.

The floor hatch lock indicator 46 may include a mechanical indicator, such as a movable pointer or a movable flag, indicating the position of the locking element 42. The floor hatch lock indicator 46 may also include an electric indicator, in particular a light source, such as an LED.

FIG. 4C depicts an alternative floor hatch locking mechanism 40 that may be unlocked manually by a person 20 using a handle or key 45, in particular a triangular key 45.

The floor hatch locking mechanism 40 depicted in FIG. 4C comprises a sliding lock 41 that is employed for securing the floor hatch 22 in the closed position. The floor hatch locking mechanism 40 includes a floor hatch locking element 42 having the form of a latch that is operable using the handle or key 45.

When the lock is engaged, the floor hatch locking element 42 extends into a corresponding strike plate 47 formed in the frame 6b of the elevator car 6, preventing the floor hatch 22 from being opened.

The floor hatch locking mechanism 40 comprises a mechanism that allows for moving the floor hatch locking element 42. When the handle or key 45 is inserted into a corresponding opening 43 and turned, it triggers the components of the sliding lock 41 to either extend the floor hatch locking element 42 into the strike plate 47 for securing the floor hatch 22 in the closed position, or to retract the floor hatch locking element from the strike plate 47 in order to allow the floor hatch 22 to open.

Optionally, the floor hatch locking mechanism 40 may comprise an elastic element (not shown), such as a spring, that is configured for urging the floor hatch locking element 42 into the strike plate 47.

On the side of the floor hatch 22 opposite to the floor hatch locking mechanism 40, FIGS. 4A and 4B show a coupling mechanism 50 that is configured for coupling the motion of the floor hatch 22 with the motion of the fixing element 34.

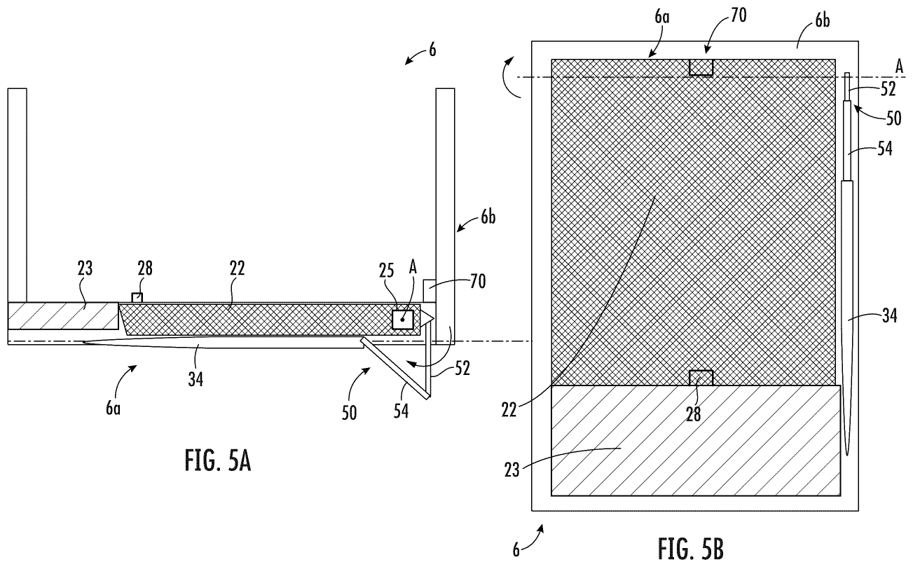

The coupling mechanism 50 is also shown in FIGS. 5A and 5B. FIG. 5A depicts a schematic sectional view of the floor 6a of the elevator car 6 with the floor hatch 22 arranged in its closed position. FIG. 5B depicts a schematic top view of the floor 6a of the elevator car 6 depicted in FIG. 5A.

For simplicity, the floor hatch locking mechanism 40 not depicted in FIGS. 5A and 5B.

As mentioned before, the floor hatch 22 is pivotable around an axis A in order to allow moving the floor hatch 22 between its closed position depicted in FIGS. 3A, 3B, and 5, and an open position as it is depicted in FIGS. 3C and 3D.

The floor hatch 22 may be provided with a handle 28 in order to allow the person 20 to manually move the floor hatch 22 using said handle 28.

Additionally or alternatively, the elevator car 6 may be provided with a floor hatch motor 25 that is configured for moving the floor hatch 22 between its opened position and its closed position.

The exemplary embodiment of the coupling mechanism 50 depicted in FIG. 5 comprises two levers 52, 54. The two levers 52, 54 are coupled with each other forming a lever structure that extends between the floor hatch 22 and the fixing element 34.

The coupling mechanism 50 includes in particular a first lever 52 having a first end that is pivotably coupled to the floor hatch 22 and a second end that is pivotably coupled to a first end of the second lever 54 of the coupling mechanism 50.

An opposing second end of the second lever 54 is pivotably coupled to the fixing element 34. The fixing element 34 is linearly movable along the floor 6a of the elevator car 6 in a horizontal direction.

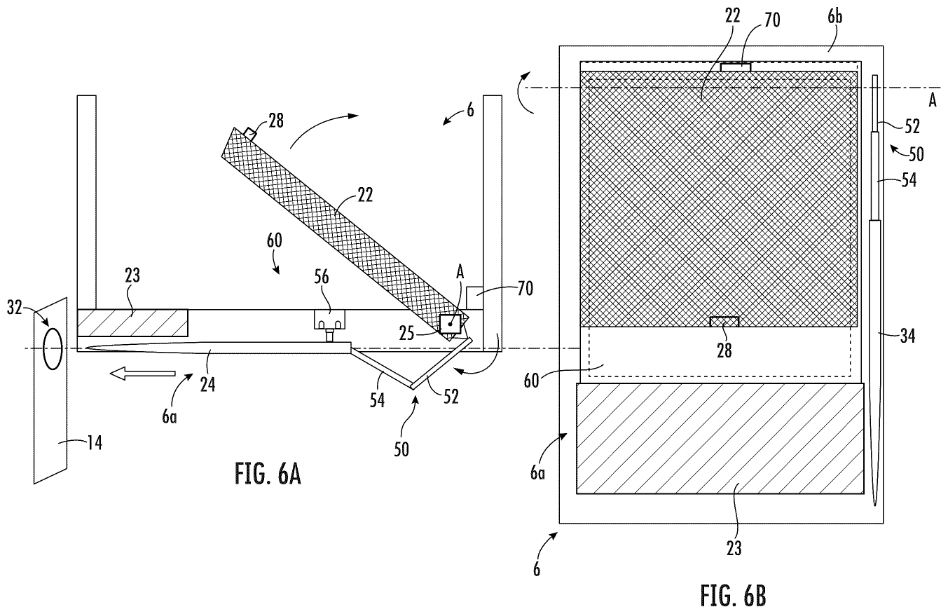

FIG. 6A depicts a schematic sectional view of the floor 6a of an elevator car 6 with the floor hatch 22 arranged in a partially open position. FIG. 6B depicts a schematic top view of the of the floor 6a of the elevator car 6 depicted in FIG. 6A.

When the floor hatch 22 is opened by pivoting the floor hatch 22 around the axis A, as it is depicted in FIGS. 6A and 6B, the two levers 52, 54 of the coupling mechanism 50 cause the fixing element 34 to move linearly parallel to the floor 6a of the elevator car 6 towards and into the corresponding fixing opening 32 provided in the hoistway 4.

Optionally, the elevator system 2 may comprise an electric safety switch 56 that is coupled to at least one of the fixing element 34, the coupling mechanism 50 and the floor hatch 22. The electric safety switch 56 may be configured for detecting movement of at least one of these components and for interrupting the supply of electric power to the motor 9 of the elevator drive system 5 as soon as the floor hatch 22 is moved out of its completely closed position depicted in FIGS. 5A and 5B.

Interrupting the supply of electric power to the motor 9 of the elevator drive system 5 may add additional safety to the elevator system 2 by preventing the elevator car 6 from being moved by the elevator drive system 5 while the floor hatch 22 is open and allows a person 20 to enter the space 24 below the elevator car 6.

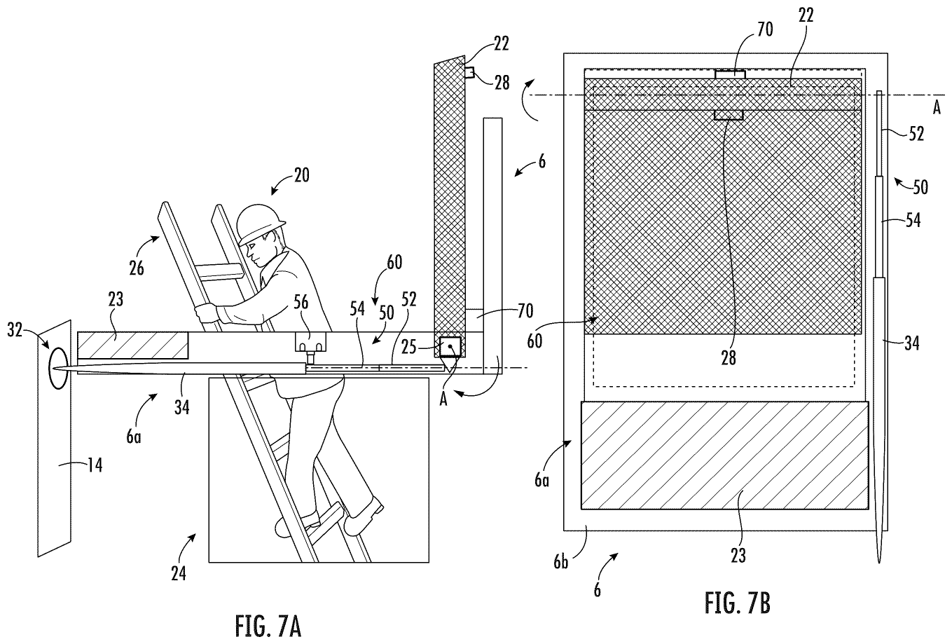

FIG. 7A depicts a schematic sectional view of the floor 6a of an elevator car 6 with the floor hatch 22 arranged in a fully open position. FIG. 7B depicts a schematic top view of the of the floor 6a of the elevator car 6 depicted in FIG. 7A.

When the floor hatch 22 is in the completely open position depicted in FIGS. 7A and 7B, the person 20 is able to enter the space 24 below the elevator car 6 through the floor opening 60 formed in the floor 6a of the elevator car 6.

When the floor hatch 22 is arranged in the completely open position, the fixing element 34 of the fixing mechanism 30 has been moved into the elevator car fixing position or activated position in which it extends into the fixing opening 32 formed in the hoistway 4. As a result, the position of the elevator car 6 in the hoistway 4 is fixed since any movement of the elevator car 6 is prevented by the fixing mechanism 30.

In the embodiment depicted in FIGS. 7A and 7B, the person 20 uses a ladder 26 extending through the floor opening 60 for safely entering the space 24 below the elevator car 6. Using a ladder 26 is, however, optional, and the person 20 may enter the space 24 below the elevator car without using a ladder 26, too.

The exemplary embodiment of the elevator system 2 further comprises a floor hatch fixing mechanism 70. The floor hatch fixing mechanism 70 is configured for fixing the floor hatch 22 in its open position in order to prevent the floor hatch 22 from accidentally closing and deactivating the elevator car fixing mechanism 30 while the person 20 is still in the hoistway 4 in the space 24 below the elevator car 6.

The floor hatch fixing mechanism 70 may in particular be configured such as to be releasable only from inside the elevator car 6 but not from outside the elevator car 6, in particular not from the space 24 below the elevator car 6. Such a floor hatch fixing mechanism 70 may enhance the safety of the elevator system 2 even further, as it may be released by the person 20 only after the person 20 has left the space 24 below the elevator car 6 and returned into the elevator car 6.

The floor hatch fixing mechanism 70 may comprise a lever, a button or a switch provided in the elevator car 6 for releasing the floor hatch fixing mechanism 70 in order to allow the floor hatch 22 to move from its open position depicted in FIGS. 7A and 7B into its closed position depicted in FIGS. 5A and 5B.

The floor hatch fixing mechanism 70 may be a purely mechanical floor hatch fixing mechanism 70 comprising only mechanical components, such as levers, springs and/or catches for mechanically fixing the floor hatch 22 in its open position.

Alternatively, the floor hatch fixing mechanism 70 may comprise electric components in addition to mechanical components, in particular electromagnetic components, such as a solenoid, for selectively fixing the floor hatch 22 in its open position.

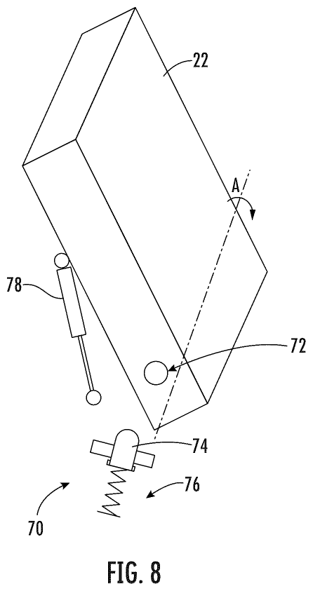

FIG. 8 depicts an exemplary embodiment of a floor hatch fixing mechanism 70 that allows fixing the floor hatch 22 in an open position.

In the exemplary embodiment of the floor hatch fixing mechanism 70 depicted in FIG. 8, an opening or hole 72 is formed in a lateral surface of the floor hatch 22.

The floor hatch fixing mechanism 70 further comprises a locking pin 74 and an elastic element 76, such as a spring.

The elastic element 76 urges the locking pin 74 into the opening or hole 72 for fixing the floor hatch 22 in the open position, preventing the floor hatch 22 from rotating out of the open position once into the closed position.

Optionally, the elevator car 6 may further be equipped with a braking jack 78 for damping and smoothening the movement of the floor hatch 22.

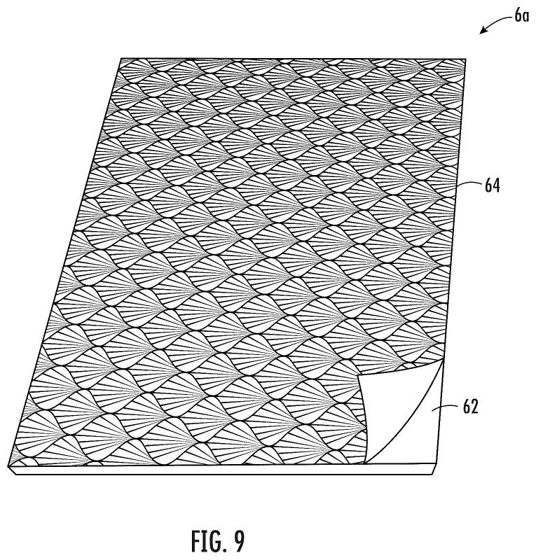

FIG. 9 shows a schematic perspective view of a portion of the floor 6a of the elevator car 6.

In the embodiment depicted in FIG. 9 the floor 6a of the elevator car 6 comprises a solid floor panel 62 that may, for example, be made of metal or a material comprising metal. The floor hatch 22 and the fixed portion 23 of the floor 6a are formed within said floor panel 62. The floor panel 62 is covered by a cover 64, such as a carpet, hiding the floor hatch 22 from the passengers of the elevator system 2.

In an embodiment, the cover 64 may be provided with a magnetic coating and/or a number of magnetic elements.

The magnetic coating and/or the magnetic elements may in particular be provided on the side of the cover 64 facing the floor panel 62 for removably fixing the cover 64 to the floor panel 62. Fixing the carpet to the floor panel 62 using a magnetic coating and/or magnetic elements allows the person 20 to easily and conveniently remove the cover 64 from the floor panel 62 for accessing and opening the floor hatch 22 and entering the space 24 below the elevator car 6.

While the invention has been described with reference to exemplary embodiments, it will be understood by those skilled in the art that various changes may be made and equivalents may be substituted for elements thereof without departing from the scope of the invention. In addition many modifications may be made to adopt a particular situation or material to the teachings of the invention without departing from the essential scope thereof. Therefore, it is intended that the invention shall not be limited to the particular embodiment disclosed, but that the invention includes all embodiments falling in the scope of the dependent claims.

What is claimed is:

1. Elevator car (6) for moving in a hoistway (4) between a plurality of landings (8a-8d);
wherein the elevator car (6) comprises a floor hatch (22) formed at a bottom of the elevator car (6) and allowing a person (20), in particular a mechanic, to access a space (24) in a portion of the hoistway (4) below the elevator car (6) from inside the elevator car (6);
the elevator car (6) further comprising at least one movable fixing element (34) that is movable between an elevator car fixing position in which it fixes the position of the elevator car (6) in a hoistway (4) at a predefined position above a bottom of the hoistway (4), and a released position, in which it does not fix the position of the elevator car (6) in the hoistway (4).

2. Elevator car (6) according to claim 1, wherein the at least one movable fixing element (34) is mechanically and/or electrically coupled with the floor hatch (22) for moving concurrently with the floor hatch (22).

3. Elevator car (6) according to claim 1, further comprising a floor hatch fixing mechanism (70) for fixing the floor hatch (22) in an open position and preventing the floor hatch (22) from accidentally closing, wherein the floor hatch fixing mechanism (70) is in particular releasable only from inside the elevator car (6).

4. Elevator car (6) according to claim 1,
wherein the floor hatch (22) comprises at least one handle (28) that allows a person (20) to move the floor hatch (22) manually between a closed position and an open position, and/or
wherein the elevator car (6) comprises a floor hatch motor (25) for moving the floor hatch (22) between the closed position and the open position.

5. Elevator car (6) according to claim 1, further comprising at least one of a lever (52, 54), a rope, a belt, a rack and a pinion coupling the floor hatch (22) with the at least one movable fixing element (34).

6. Elevator system (2) comprising
a hoistway (4) extending between a plurality of landings (8a-8d); and
an elevator car (6) according to claim 1.

7. Elevator system (2) according to claim 6, comprising
at least one fixing opening (32) provided in the hoistway (4), in particular in a wall (4b) of the hoistway (4) or in a guide rail (14) extending through the hoistway (4);
wherein the at least one movable fixing element (34) extends into the at least one fixing opening (32) when it is arranged in the elevator car fixing position, and
wherein the at least one movable fixing element (34) does not extend into the at least one fixing opening (32) when it is arranged in the released position.

8. Elevator system (2) according to claim 6, further comprising a floor hatch locking mechanism (40) for locking the floor hatch (22) in a closed position when the elevator car (6) is not positioned at the predefined position in the hoistway (4), and for unlocking the floor hatch (22) when the elevator car (6) is positioned at the predefined position in the hoistway (4).

9. Elevator system (2) according to claim 8, wherein the floor hatch locking mechanism (40) comprises:
a locking element (42) provided at the elevator car (6), the locking element (42) being movable between a locked position in which it locks the floor hatch (22), and an unlocked position in which it does not lock the floor hatch (22).

10. Elevator system (2) according to claim 9, wherein the floor hatch locking mechanism (40) further comprises an actuator (44), such as a roller, provided in the hoistway (4) and configured for moving the locking element (42) from the locked position into the unlocked position when the elevator car (6) is located at the predefined position.

11. Elevator system (2) according to claim 8 comprising a floor hatch lock indicator (46) indicating whether the floor hatch (22) is locked by the floor hatch locking mechanism (40).

12. Elevator system (2) according to claim 6, further comprising a controller (15) for controlling the movement of the elevator car (6) in the hoistway (4), wherein the elevator controller (15) is switchable into a maintenance mode that differs from the mode of normal operation and in which the elevator controller (15) is configured for positioning the elevator car (6) at the predefined position in the hoistway (4).

13. Elevator system (2) according to claim 6, further comprising a plurality of landing doors (10a-10d) provided at the plurality of landings (8a-8d), including a lowest landing door (10a) provided at the lowest landing (8a), wherein the lowest landing door (10a) does not comprise a manual unlocking mechanism (16) which allows for manually unlocking the lowest landing door (10a) from the lowest landing (8a).

14. Method of accessing a space (24) in the hoistway (4) of an elevator system (2) according to claim 6, wherein the method includes:
moving the elevator car (6) to a predefined position in the hoistway (4);
opening the floor hatch (22) provided at the bottom of the elevator car (6), thereby activating the at least one movable fixing element (34) to fix the position of the elevator car (6) in the hoistway (4) at the predefined position above the bottom of the hoistway (4); and
accessing the space (24) in the hoistway (4) below the elevator car (6) from the elevator car (6) via a floor opening (69) formed in a floor (6a) of the elevator car (6).

15. Method according to claim 14, wherein the method further includes fixing the floor hatch (22) in its open position, in particular by activating a floor hatch fixing mechanism (70) that may be released only from inside the elevator car (6).
